(19) United States
(12) Patent Application Publication
(10) Pub. No.: US 2026/0186373 A1
(43) Pub. Date: Jul. 2, 2026

(54) IMAGE CAPTURING DEVICE AND ELECTRONIC DEVICE WITH IMAGE CAPTURING

(71) Applicant: Luxvisions Innovation Technology Corp. Limited, Guangzhou City (CN)

(72) Inventors: Kai-Chih Liang, Guangzhou City (CN); Hung-Hsien Chou, Guangzhou City (CN); Lee-Lin Tsai, Guangzhou City (CN); Yung-Chou Chen, Guangzhou City (CN)

(73) Assignee: Luxvisions Innovation Technology Corp. Limited, Guangzhou City (CN)

(21) Appl. No.: 19/387,901

(22) Filed: Nov. 13, 2025

(30) Foreign Application Priority Data
Dec. 26, 2024 (CN) 202411942377.9

(51) Int. Cl. G03B 9/02; G02F 1/133; G02F 1/1333; G02F 1/1335

(52) U.S. Cl. CPC G03B 9/02; G02F 1/13306; G02F 1/133308; G02F 1/133528

(57) ABSTRACT

An image capturing device includes a liquid crystal aperture module, a driving module, and a shooting module. The liquid crystal aperture module has an aperture center and includes a first polarizer, a second polarizer, a first substrate and a second substrate between the first polarizer and the second polarizer, and a liquid crystal layer including a plurality of liquid crystal molecules and between the first substrate and the second substrate. Each liquid crystal molecule has an arrangement direction. The driving module is electrically connected to the first substrate and the second substrate of the liquid crystal aperture module to control the arrangement direction of each liquid crystal molecule of the liquid crystal layer to change. The shooting module is located downstream of the liquid crystal aperture module in an optical path. The shooting module includes a sensing module having a sensing optical axis aligned with the aperture center.

### CROSS-REFERENCE TO RELATED APPLICATION

This non-provisional application claims priority under 35 U.S.C. § 119(a) to Patent Application No. 202411942377.9 filed in China on December 26, 2024, the entire contents of which are hereby incorporated by reference.

### BACKGROUND

### TECHNICAL FIELD

The present invention relates to an image capturing device, and in particular, to an image with an aperture.

### Related Art

With the development of technologies, an image capturing device of an electronic device has changed from a simple low-pixel photography to a multi-lens, high-resolution, and multi-functional photography today. However, a need to effectively control a plurality of shooting parameters such as an aperture, a shutter speed, sensitivity, a focal length, and exposure compensation during shooting still exists.

The aperture affects an amount of light entering, a depth of field, an image sharpness, and an exposure control flexibility. When adjusting an aperture size, a shooting device mostly relies on mechanical control of opening and closing blades to adjust the aperture size. Therefore, when designing and using the aperture, more attention should be paid to a volume, a durability, a high-precision control, and an accurate assembly of the aperture.

Specifically, an advanced electronic device is designed to be thin. An aperture thickness can be easily increased through mechanical control of aperture blades, and inevitable mechanical wear may occur after use time increases. In addition, a condition such as an interference that affects an image quality of the image capturing device when the image capturing device leaves a factory or after being used for a period of time due to an inaccurate assembly is also easily caused.

### SUMMARY

In view of the above, an image capturing device is provided, including a liquid crystal aperture module, a driving module, and a shooting module. The liquid crystal aperture module includes a first polarizer, a second polarizer, a first substrate, a second substrate, and a liquid crystal layer. The liquid crystal layer is located between the first substrate and the second substrate. The first substrate and the second substrate are located between the first polarizer and the second polarizer. The liquid crystal layer includes a plurality of liquid crystal molecules. Each liquid crystal molecule has an arrangement direction. The liquid crystal aperture module has an aperture center. The driving module is electrically connected to the first substrate and the second substrate of the liquid crystal aperture module to control the arrangement direction of each liquid crystal molecule of the liquid crystal layer to change. The shooting module is located downstream of the liquid crystal aperture module in an optical path. The shooting module includes a sensing module having a sensing optical axis. The sensing optical axis is aligned with the aperture center of the liquid crystal aperture module.

In an embodiment, the arrangement directions of the liquid crystal molecules of the liquid crystal layer include a first direction and a second direction. The driving module controls a part of the plurality of liquid crystal molecules to be arranged in the first direction. The liquid crystal molecules arranged in the first direction form a light-transmissive region to allow imaging light to penetrate and enter the shooting module. The driving module controls a part of the plurality of liquid crystal molecules to be arranged in the second direction. The liquid crystal molecules arranged in the second direction form a light-proof region to prevent the imaging light from penetrating and entering the shooting module.

In an embodiment, the shooting module further includes a lens module located between the liquid crystal aperture module and the sensing module. A side of the lens module facing the liquid crystal aperture module has a lens diameter. The liquid crystal aperture module has a maximum aperture diameter. The maximum aperture diameter is greater than or equal to the lens diameter.

In an embodiment, the driving module includes a driving circuit and a controller. The controller is electrically connected to the shooting module. The controller controls the driving circuit to apply a voltage to the liquid crystal aperture module, to change the arrangement direction of each liquid crystal molecule of the liquid crystal layer of the liquid crystal aperture module.

In an embodiment, the liquid crystal molecules are twisted nematic (TN) liquid crystals, vertical alignment (VA) liquid crystals, or in-plane switching (IPS) liquid crystals.

In an embodiment, a base and a circuit board are further included. The shooting module and the driving module are arranged on the circuit board. The base is fixed to the shooting module and electrically connected to the driving module through a circuit. The liquid crystal aperture module is arranged on the base and electrically connected to the base.

In an embodiment, the circuit is formed on the base by laser direct structuring.

In an embodiment, the circuit is a metal conductive sheet. The metal conductive sheet is embedded in the base by insert molding.

In an embodiment, the base includes a plurality of contacts. Each contact is applied with a conductive adhesive. The first substrate and the second substrate are electrically connected to each contact through the conductive adhesive.

In an embodiment, a circuit board is further included. The circuit board includes a first board, a second board, and a third board. The first board is connected to the third board through the second board. The shooting module and the driving module are arranged on the first board. The liquid crystal aperture module is arranged on the third board. The second board is bendable, so that the liquid crystal aperture module is located on the shooting module, and the aperture center of the liquid crystal aperture module is aligned with the sensing optical axis of the sensing module of the shooting module.

In an embodiment, a base is further included. The base is fixed to the shooting module. The liquid crystal aperture module is arranged on the base.

In an embodiment, an optical steering element located between the liquid crystal aperture module and the shooting module is further included. The optical steering element has an incident surface, a reflective surface, and an emergent surface. The liquid crystal aperture module is attached to the incident surface, so that imaging light penetrating the aperture center of the liquid crystal aperture module is allowed to penetrate the incident surface, be reflected by the reflective surface, and penetrate the emergent surface to enter the sensing optical axis of the sensing module.

The present invention further provides an electronic device with image capturing, including an input interface, an image capturing device, a main board, and a display. The input interface is configured to receive an input instruction. The image capturing device is connected to the input interface. The image capturing device includes a liquid crystal aperture module, a driving module, and a shooting module. The liquid crystal aperture module includes a first polarizer, a second polarizer, a first substrate, a second substrate, and a liquid crystal layer. The liquid crystal layer is located between the first substrate and the second substrate. The first substrate and the second substrate are located between the first polarizer and the second polarizer. The liquid crystal layer includes a plurality of liquid crystal molecules. Each of the liquid crystal molecules has an arrangement direction. The liquid crystal aperture module has an aperture center. The driving module is electrically connected to the input interface, the first substrate, and the second substrate to control the arrangement direction of each liquid crystal molecule of the liquid crystal layer to change based on the input instruction. The shooting module is located downstream of the liquid crystal aperture module in an optical path. The shooting module includes a sensing module having a sensing optical axis. The sensing optical axis is aligned with the aperture center of the liquid crystal aperture module. The sensing module captures an image of a target object and converts the image into an image signal based on the input instruction. The main board is connected to the image capturing device. The main board receives the image signal from the image capturing device. The display is connected to the main board. The display has an opening. The liquid crystal aperture module is located at the opening. The display displays an image based on the image signal after receiving the image signal through the main board.

The present invention further provides an electronic device with image capturing, including an input interface, an image capturing device, a main board, a display, and a housing. The input interface is configured to receive an input instruction. The image capturing device is connected to the input interface. The image capturing device includes a liquid crystal aperture module, a driving module, and a shooting module. The liquid crystal aperture module includes a first polarizer, a second polarizer, a first substrate, a second substrate, and a liquid crystal layer. The liquid crystal layer is located between the first substrate and the second substrate. The first substrate and the second substrate are located between the first polarizer and the second polarizer. The liquid crystal layer includes a plurality of liquid crystal molecules. The liquid crystal molecules each have an arrangement direction. The liquid crystal aperture module has an aperture center. The driving module is electrically connected to the input interface, the first substrate, and the second substrate to control the arrangement direction of each liquid crystal molecule of the liquid crystal layer to change based on the input instruction. The shooting module is located downstream of the liquid crystal aperture module in an optical path. The shooting module includes a sensing module having a sensing optical axis. The sensing optical axis is aligned with the aperture center of the liquid crystal aperture module. The sensing module captures an image of a target object and converts the image into an image signal based on the input instruction. The main board is connected to the image capturing device. The main board receives the image signal from the image capturing device. The display displays an image based on the image signal after receiving the image signal through the main board. The housing has a window. The main board and the shooting module are arranged in the housing and the display. The liquid crystal aperture module is arranged in the window.

The present invention is described in detail below with reference to drawings and specific embodiments, which are not construed as a limitation on the present invention.

### BRIEF DESCRIPTION OF THE DRAWINGS

FIG. 1 is a three-dimensional view of an image capturing device according to an embodiment.

FIG. 2 is a three-dimensional exploded view of the image capturing device according to the embodiment of FIG. 1.

FIG. 3 is a cross-sectional view of the image capturing device according to the embodiment of FIG. 1.

FIG. 4 is a cross-sectional view of a liquid crystal aperture module and a driving module according to an embodiment.

FIG. 5a is a schematic diagram of a liquid crystal aperture module according to an embodiment.

FIG. 5b is a schematic top view of the liquid crystal aperture module according to the embodiment of FIG. 5a.

FIG. 6a is a schematic diagram of a liquid crystal aperture module according to another embodiment.

FIG. 6b is a schematic top view of the liquid crystal aperture module according to the embodiment of FIG. 6a.

FIG. 7a is a schematic diagram of a liquid crystal aperture module according to yet another embodiment.

FIG. 7b is a schematic top view of the liquid crystal aperture module according to the embodiment of FIG. 7a.

FIG. 8 is a schematic diagram of a driving module applying a voltage to a liquid crystal aperture module according to an embodiment.

FIG. 9 is a schematic diagram of a driving module applying a voltage to a liquid crystal aperture module according to another embodiment.

FIG. 10 is a schematic diagram of a driving module applying a voltage to a liquid crystal aperture module according to yet another embodiment.

FIG. 11 is a cross-sectional view of a liquid crystal aperture module and a driving module according to another embodiment.

FIG. 12 is a cross-sectional view of a liquid crystal aperture module and a driving module according to yet another embodiment.

FIG. 13 is a cross-sectional view of a liquid crystal aperture module and a driving module according to yet another embodiment.

FIG. 14 is a three-dimensional view of an image capturing device according to another embodiment.

FIG. 15 is a three-dimensional exploded view of an image capturing device according to another embodiment.

FIG. 16 is a three-dimensional view of the image capturing device of FIG. 15, showing an unfolded state of a circuit board.

FIG. 17 is a three-dimensional view of the image capturing device of FIG. 16, showing a bent state of a circuit board.

FIG. 18 is a cross-sectional view of an image capturing device according to yet another embodiment.

FIG. 19 is a schematic diagram of an electronic device with image capturing according to an embodiment.

FIG. 20 is a cross-sectional view of the electronic device with image capturing of FIG. 19.

FIG. 21 is a schematic diagram of an electronic device with image capturing according to another embodiment.

### DETAILED DESCRIPTION

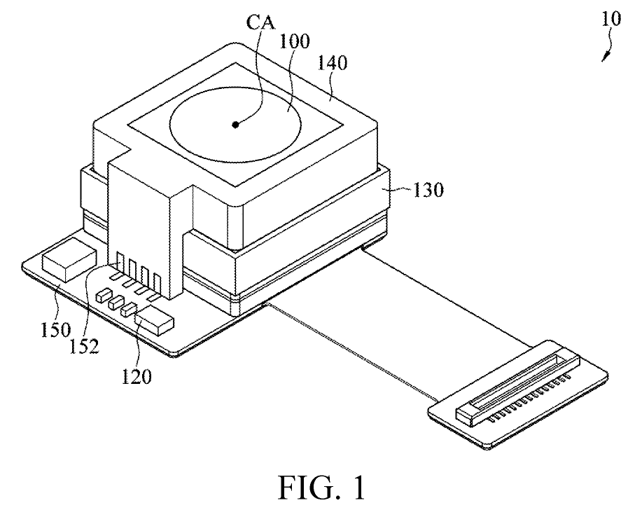

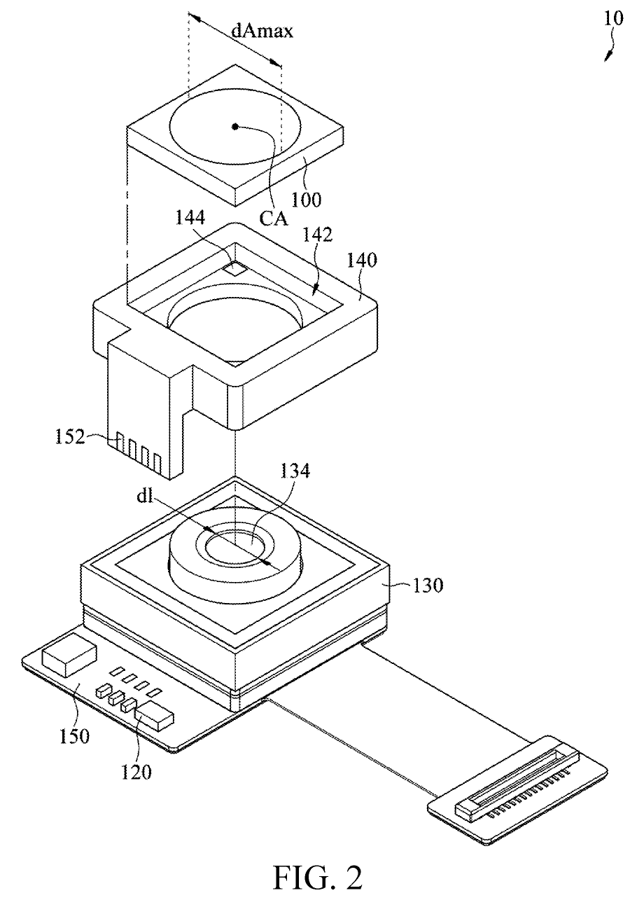

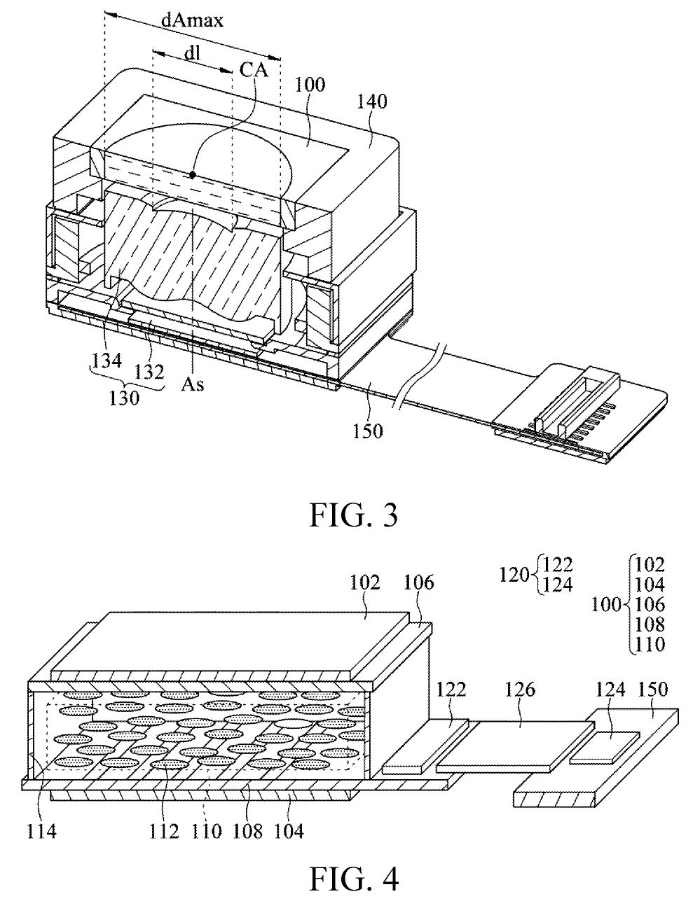

Referring to FIG. 1 to FIG. 3, FIG. 1 is a three-dimensional view of an image capturing device according to an embodiment. FIG. 2 is a three-dimensional exploded view of the image capturing device according to the embodiment of FIG. 1. FIG. 3 is a cross-sectional view of the image capturing device according to the embodiment of FIG. 1. The image capturing device 10 includes a liquid crystal aperture module 100, a driving module 120, and a shooting module 130. The driving module 120 is electrically connected to the liquid crystal aperture module 100. The shooting module 130 is located downstream of the liquid crystal aperture module 100 in an optical path. The shooting module 130 includes a sensing module 132. The sensing module 132 has a sensing optical axis As. The liquid crystal aperture module 100 has an aperture center CA. The sensing optical axis As of the sensing module 132 is aligned with the aperture center CA of the liquid crystal aperture module 100.

In some embodiments, the shooting module 130 is configured to take an image of an object or an environment. During shooting by the shooting module 130, light from the object or the environment to be photographed enters the shooting module 130 and is captured through the sensing module 132 in the shooting module 130 to form the image.

When the liquid crystal aperture module 100 is arranged upstream of the shooting module 130 in an optical path, the light of the object or the environment first penetrates the liquid crystal aperture module 100 first. Referring to FIG. 4, FIG. 4 is a cross-sectional view of a liquid crystal aperture module and a driving module according to an embodiment. The liquid crystal aperture module 100 includes a first polarizer 102, a second polarizer 104, a first substrate 106, a second substrate 108, and a liquid crystal layer 110. The liquid crystal layer 110 is located between the first substrate 106 and the second substrate 108. The first substrate 106 and the second substrate 108 are located between the first polarizer 102 and the second polarizer 104. In other words, elements between the first polarizer 102 and the second polarizer 104 of the liquid crystal aperture module 100 are sequentially the first polarizer 102, the first substrate 106, the liquid crystal layer 110, the second substrate 108, and the second polarizer 104.

The liquid crystal layer 110 includes a plurality of liquid crystal molecules 112. The liquid crystal molecules 112 each have an arrangement direction. The driving module 120 is electrically connected to the first substrate 106 and the second substrate 108 of the liquid crystal aperture module 100. When the driving module 120 applies a voltage to the liquid crystal aperture module 100, the arrangement directions of the liquid crystal molecules 112 in the liquid crystal layer 110 change, and therefore light may be allowed or not allowed to penetrate the liquid crystal layer 110. In this way, an amount of the light entering the sensing module 132 of the shooting module 130 is controlled. Therefore, an exposure, a depth of field effect, an image quality, and the like of the image photographed by the shooting module 130 are affected.

In some embodiments, the liquid crystal molecules 112 may be a twisted nematic (TN) liquid crystal, a vertical alignment (VA) liquid crystal, or an in-plane switching (IPS) liquid crystal, and the like, which are not limited herein.

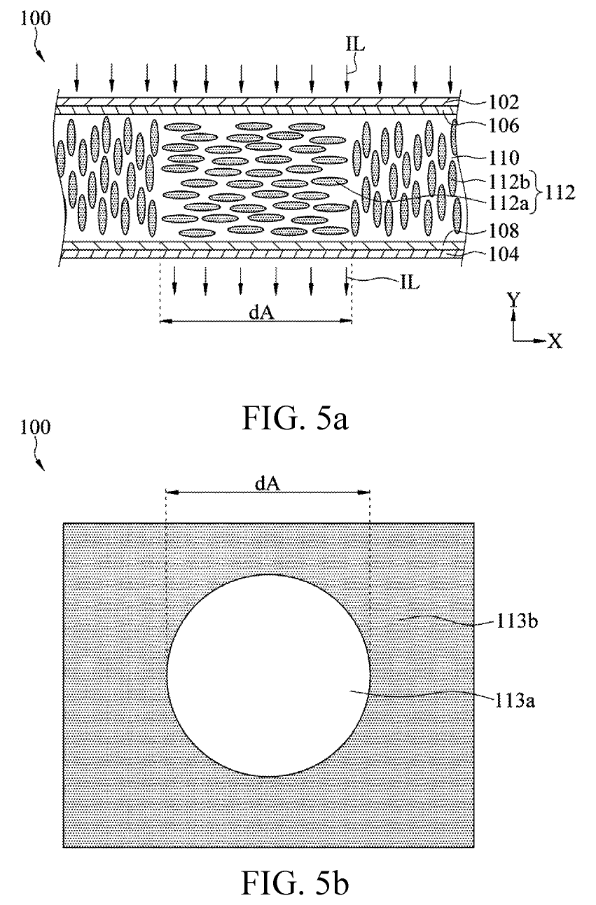

Additionally referring to FIG. 4, FIG. 5a, and FIG. 5b, FIG. 5a is a schematic diagram of a liquid crystal aperture module according to an embodiment. FIG. 5b is a schematic top view of the liquid crystal aperture module according to the embodiment of FIG. 5a. FIG. 5a illustrates the liquid crystal molecules 112 by way of example as vertical alignment (VA) liquid crystal. In some embodiments, the arrangement directions of the liquid crystal molecules 112 in the liquid crystal layer 110 include a first direction and a second direction. An arrangement direction of liquid crystal molecules 112a is taken as the first direction and an arrangement direction of liquid crystal molecules 112b is taken as the second direction herein. The driving module 120 may control the liquid crystal molecules 112 to be partially arranged in the first direction and partially arranged in the second direction.

In some embodiments, the liquid crystal molecules 112 (the liquid crystal molecules 112a shown in FIG. 5a) arranged in the first direction form a light-transmissive region 113a to allow the light (referred to as imaging light IL below) entering the image capturing device 10 to penetrate and enter the shooting module 130. The liquid crystal molecules 112 (the liquid crystal molecules 112b shown in FIG. 5a) arranged in the second direction form a light-proof region 113b to prevent the imaging light IL entering the image capturing device 10 from penetrating.

In an embodiment in which the liquid crystal molecules 112 are the VA liquid crystal, the liquid crystal molecules 112 in the liquid crystal layer 110 are arranged in the second direction in an initial state when no voltage is applied. When the driving module 120 applies the voltage to the liquid crystal aperture module 100, the liquid crystal molecules 112 in the liquid crystal layer 110 affected by such an external voltage changes the arrangement direction from the aperture center CA to being arranged in the first direction to allow the imaging light IL to penetrate.

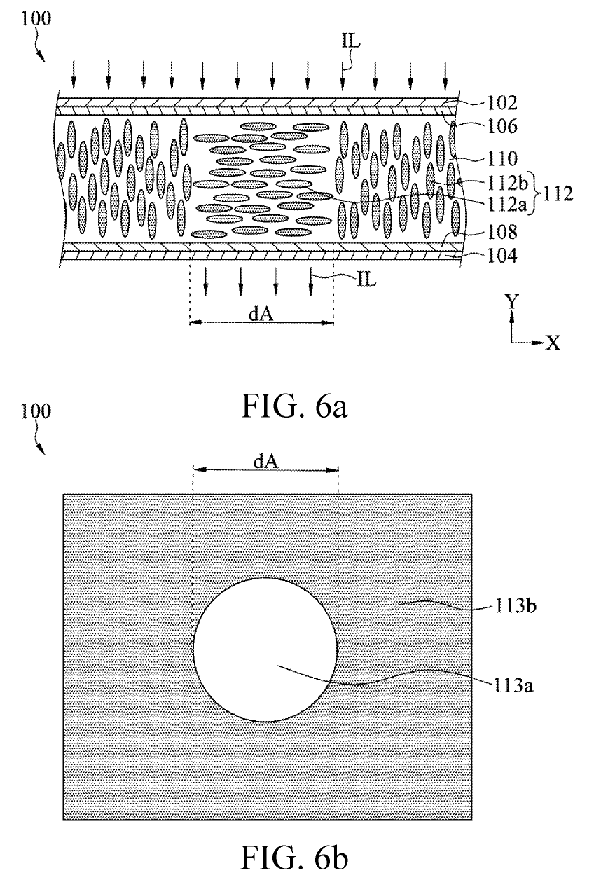

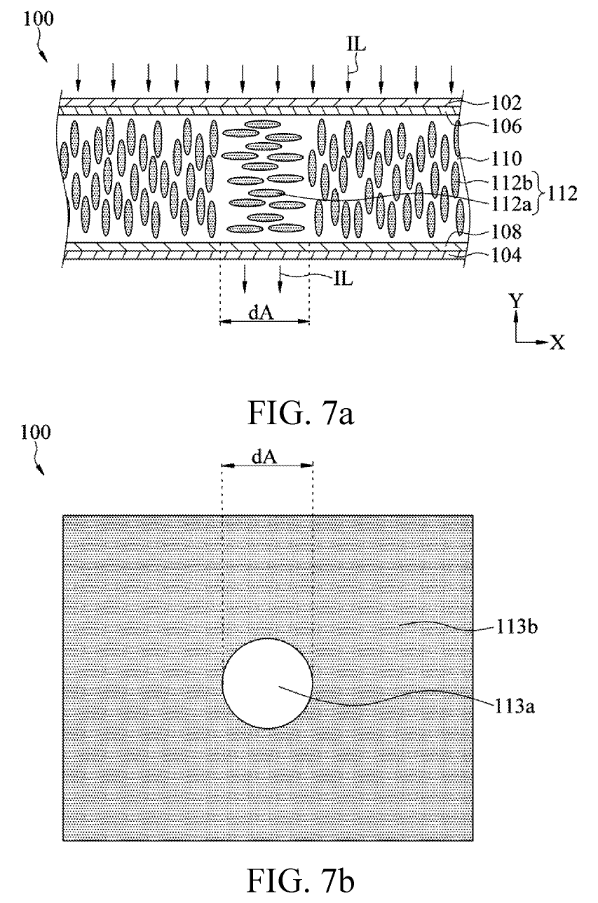

Referring to FIG. 6a and FIG. 7a, FIG. 6a is a schematic diagram of a liquid crystal aperture module according to another embodiment. FIG. 7a is a schematic diagram of a liquid crystal aperture module according to yet another embodiment. In some embodiments, the driving module 120 controls an area size of a region where a voltage is applied to the liquid crystal molecules 112 in the liquid crystal aperture module 100, so that the area sizes of the light-transmissive region 113a and the light-proof region 113b may be adjusted, thereby achieving effect of adjusting an aperture size of the liquid crystal aperture module 100.

An embodiment in which the liquid crystal molecules 112 are the VA liquid crystal and arranged in the second direction in an initial state when no voltage is applied is taken as an example. When the driving module 120 applies the voltage to the liquid crystal aperture module 100, an arrangement manner of the liquid crystal molecules 112 changes from the second direction to the first direction from the aperture center CA to form the light-transmissive region 113a. A larger area where the driving module 120 applies the voltage to the liquid crystal molecules 112 indicates a larger area of the light-transmissive region 113a. In some embodiments, a size of the light-transmissive region 113a may be controlled by increasing or decreasing an area of the liquid crystal layer 110 controlled by a voltage of a patterned indium tin oxide (ITO) electrode, so as to achieve an aperture effect.

Refer to FIG. 5a, FIG. 6a, and FIG. 7a together as well as FIG. 5b, FIG. 6b, and FIG. 7b together. FIG. 6b is a schematic top view of the liquid crystal aperture module according to the embodiment of FIG. 6a. FIG. 7b is a schematic top view of the liquid crystal aperture module according to the embodiment of FIG. 7a. In the foregoing embodiment, a larger light-transmissive region 113a indicates a larger aperture diameter dA formed by the liquid crystal aperture module 100. On the contrary, a smaller light-transmissive region 113a indicates a smaller aperture diameter dA formed by the liquid crystal aperture module.

In some other embodiments, if an embodiment in which the liquid crystal molecules 112 are the VA liquid crystal and arranged in the second direction in the initial state when no voltage is applied is used as an example, the arrangement manner of the liquid crystal molecules 112 is maintained in the second direction when the driving module 120 does not apply the voltage to the liquid crystal aperture module 100. Therefore, the liquid crystal layer 110 does not have the light-transmissive region 113a and is the light-proof region 113b completely. In this case, the liquid crystal aperture module 100 may also be used as a closed shutter of the shooting module 130, so as to achieve an electronically controlled light shielding effect to shield the imaging light IL from entering the shooting module 130.

Referring back to FIG. 3, in some embodiments, the shooting module 130 includes a lens module 134. The lens module 134 is located between the sensing module 132 and the liquid crystal aperture module 100. A side of the lens module 134 facing the liquid crystal aperture module 100 has a lens diameter dl. The liquid crystal aperture module 100 has a maximum aperture diameter dAmax. The maximum aperture diameter dAmax is greater than or equal to the lens diameter dl.

In the foregoing embodiment in which the liquid crystal molecules 112 in the liquid crystal layer 110 are the VA liquid crystal and arranged in the second direction in the initial state when no voltage is applied, the liquid crystal molecules 112 in the liquid crystal layer 110 are arranged in the first direction when the driving module 120 applies the voltage to the liquid crystal aperture module 100. In this case, the liquid crystal layer 110 of the liquid crystal aperture module 100 does not have the light-proof region 113b, and the aperture diameter dA of the liquid crystal aperture module 100 is the maximum aperture diameter dAmax. The maximum aperture diameter dAmax of the liquid crystal aperture module 100 is greater than or equal to the lens diameter dl, which can prevent the aperture of the shooting module 130 from being limited by the maximum aperture diameter dAmax of the liquid crystal aperture module 100 when a maximum aperture requirement of the shooting module 130 is imposed.

In some embodiments, the light-transmissive region 113a and the light-proof region 113b are concentric circles centered on the aperture center CA. When the driving module 120 applies the voltage to the liquid crystal layer 110 to change the direction of the liquid crystal molecules 112, the light-transmissive region 113a is formed starting from the aperture center CA.

In some embodiments, when the liquid crystal aperture module 100 and the shooting module 130 are integrated into the image capturing device 10, the sensing optical axis As of the shooting module 130 may be confirmed first. Then, a position of the liquid crystal aperture module 100 corresponding to the sensing optical axis As may be taken as the aperture center CA. A control manner of the driving module 120 is set based on the aperture center CA.

In some embodiments, the first polarizer 102 and the second polarizer 104 are configured to generate a linearly polarized light from the imaging light IL to cooperate with the liquid crystal layer 110 to achieve the aperture effect. The first polarizer 102 and the second polarizer 104 may be adjusted based on a type of the liquid crystal molecules 112. For example, when the liquid crystal molecules 112 are the TN liquid crystal, polarization angles of the first polarizer 102 and the second polarizer 104 may be perpendicular to each other.

In some embodiments, the first substrate 106 and the second substrate 108 are respectively ITO conductive glass with patterned ITO electrodes. The driving module 120 is electrically connected to the first substrate 106 and the second substrate 108 to provide an electric field required for controlling the arrangement directions of the liquid crystal molecules 112.

In some embodiments, the first substrate 106 and the second substrate 108 are applied with an alignment film to control the arrangement directions of the liquid crystal molecules 112 when the driving module 120 does not apply the voltage to the liquid crystal aperture module 100.

Still referring to FIG. 4, in some embodiments, the liquid crystal aperture module 100 includes a frame sealant 114, which is configured to seal the liquid crystal molecules 112 to the liquid crystal layer 110 and fix the first substrate 106 and the second substrate 108.

Still referring to FIG. 1 or FIG. 4, in some embodiments, the driving module 120 includes a driving circuit 122 and a controller 124. The controller 124 is electrically connected to the shooting module 130. The controller 124 may control the driving circuit 122 to apply the voltage to the liquid crystal aperture module 100 based on a requirement of the shooting module 130 when a user shoots with the image capturing device 10, so as to adjust a size of the light-transmissive region 113a or a size of the light-proof region 113b in the liquid crystal layer 110.

In some embodiments, in addition to controlling the aperture diameter dA of the liquid crystal aperture module 100 with the driving module 120, a light transmittance of the liquid crystal aperture module 100 may also be controlled. In some embodiments, that the liquid crystal molecules 112 are the VA liquid crystal is taken as an example, and a larger voltage applied to the liquid crystal molecules 112 allows more imaging light IL to penetrate the liquid crystal molecules 112 and a higher light transmittance of the liquid crystal aperture module 100. In some other embodiments, that the liquid crystal molecules 112 are the TN liquid crystal is used as an example, and a smaller voltage applied to the liquid crystal molecules 112 allows more imaging light IL to penetrate the liquid crystal molecules 112 and a higher light transmittance of the liquid crystal aperture module 100.

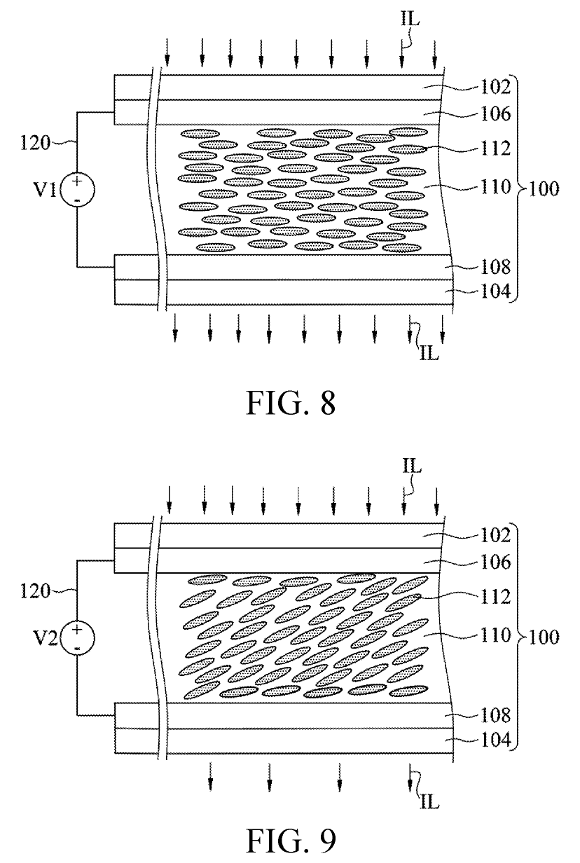

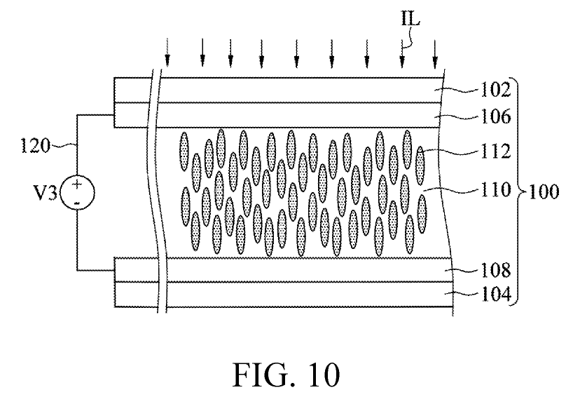

Referring to FIG. 8, FIG. 8 is a schematic diagram of a driving module applying a voltage to a liquid crystal aperture module according to an embodiment. FIG. 9 is a schematic diagram of a driving module applying a voltage to a liquid crystal aperture module according to another embodiment. FIG. 10 is a schematic diagram of a driving module applying a voltage to a liquid crystal aperture module according to yet another embodiment. FIG. 8, FIG. 9, and FIG. 10 illustrate the liquid crystal molecules 112 by way of example as the TN liquid crystal. In FIG. 8, FIG. 9, and FIG. 10, the driving module 120 respectively applies a voltage V1, a voltage V2, and a voltage V3 to the liquid crystal aperture module 100. In the embodiment of FIG. 8, the voltage V1=0 V. The liquid crystal molecules 112 are arranged in the first direction when no voltage is applied and allows the imaging light IL to penetrate, and the light transmittance of the liquid crystal aperture module 100 is 100%. In the embodiment of FIG. 10, the voltage V3 > the voltage V1. The liquid crystal molecules 112 are influenced by the voltage V3 to change an arrangement direction thereof to the second direction, so that imaging light IL cannot pass through the liquid crystal layer 110, and the light transmittance of the liquid crystal aperture module 100 is 0%. In the embodiment of FIG. 9, the voltage V3 > the voltage V2 > the voltage V1. The liquid crystal molecules 112 are influenced by the voltage V2 to change the arrangement direction thereof between the first direction and the second direction, so that a part of the imaging light IL can pass through the liquid crystal layer 110, and the light transmittance of the liquid crystal aperture module 100 may in a range of 0% to 100%, for example, the light transmittance may be 75%.

In these embodiments, a lower light transmittance of the liquid crystal aperture module 100 indicates a lower light amount of the imaging light IL penetrating the liquid crystal aperture module 100 and entering the shooting module 130. When the image capturing device 10 is used, the controller 124 of the driving module 120 controls the voltage applied by the driving circuit 122 to the liquid crystal aperture module 100 based on the requirement of the shooting module 130 when the user shoots with the image capturing device 10, so as to adjust the light transmittance of the liquid crystal aperture module 100.

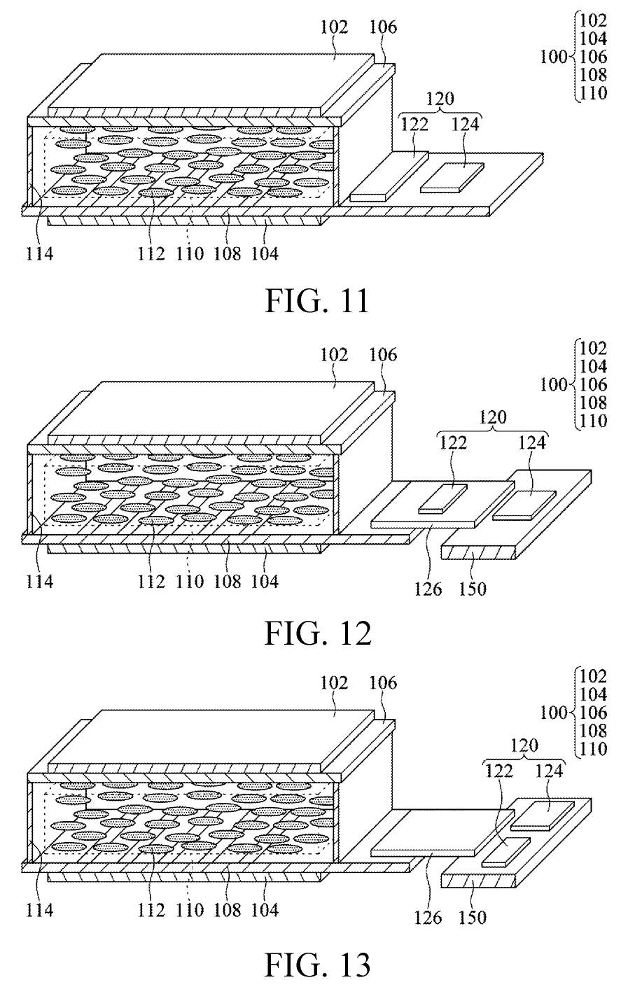

Referring to FIG. 11, FIG. 11 is a cross-sectional view of a liquid crystal aperture module and a driving module according to another embodiment. In some embodiments, the driving circuit 122 and the controller 124 of the driving module 120 are arranged on the second substrate 108, to be electrically connected to the second substrate 108.

Still referring to FIG. 4, in some embodiments, merely the driving circuit 122 is arranged on the second substrate 108 to be electrically connected to the second substrate 108. The controller 124 is additionally arranged on a circuit board 150. The circuit board 150 may be a circuit board 150 configured to supply power to the shooting module 130, which is not limited herein. The circuit board is electrically connected to a carrier board 126 between the controller 124 and the driving circuit 122. In some embodiments, the carrier board 126 is a chip-on-film (COF) or a flexible printed circuit board (FPC).

Referring to FIG. 12 and FIG. 13, FIG. 12 is a cross-sectional view of a liquid crystal aperture module and a driving module according to yet another embodiment. FIG. 13 is a cross-sectional view of a liquid crystal aperture module and a driving module according to yet another embodiment. In some embodiments, the driving circuit 122 and the controller 124 are both arranged on the circuit board 150 and are electrically connected to the liquid crystal aperture module 100 through the carrier board 126. In some other embodiments, one of the driving circuit 122 and the controller 124 may be arranged on the circuit board 150, and the other is arranged on the carrier board 126. The liquid crystal aperture module 100 is electrically connected to the carrier board 126. In this way, the driving module 120 can be electrically connected to the liquid crystal aperture module 100, so that the driving circuit 122 can apply the voltage to the liquid crystal aperture module 100 to control an aperture diameter dA of the liquid crystal aperture module 100 or the light transmittance of the liquid crystal aperture module 100.

Still referring to FIG. 2, in some embodiments, the image capturing device 10 further includes a base 140 and the circuit board 150. The shooting module 130 and the driving module 120 are arranged on the circuit board 150. The base 140 is fixed to the shooting module 130 and electrically connected to the driving module 120 through a circuit 152. The liquid crystal aperture module 100 is arranged on the base 140 and electrically connected to the base 140.

In some embodiments, the base 140 includes a plurality of contacts 144. Each contact 144 may be applied with a conductive adhesive to electrically connect the liquid crystal aperture module 100 to the base 140. The base 140 has an inner wall 142. The inner wall 142 may be applied with a colloid such as photo-curing resin to fix the liquid crystal aperture module 100 to the base 140. The base 140 may be fixed to the shooting module 130 through gluing or the like.

In some embodiments, the circuit 152 configured to electrically connect the base 140 and the driving module 120 is a metal conductive sheet. The metal conductive sheet may be embedded in the base 140 through an insert molding process to be integrally formed with the base 140. The metal conductive sheet is pin-welded with signal pins of the shooting module 130 and the driving module 120 arranged on the circuit board 150. In this way, the liquid crystal aperture module 100 is electrically connected to the driving module 120, and the aperture diameter dA of the liquid crystal aperture module 100 can be controlled through the driving module 120.

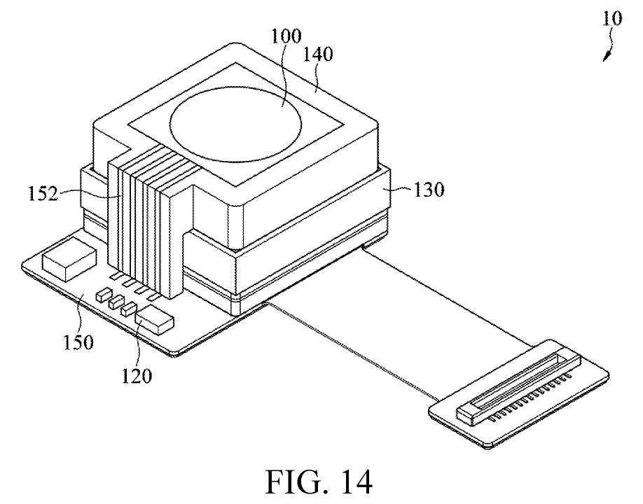

Reference FIG. 14, FIG. 14 is a three-dimensional view of an image capturing device according to another embodiment. In some other embodiments, the circuit 152 configured to electrically connect the base 140 and the driving module 120 is formed on the base 140 through laser direct structuring. When the base 140 is fixed to the shooting module 130, the circuit 152 is pin-welded with the signal pins of the shooting module 130 and the driving module 120 located on the circuit board 150, so that the liquid crystal aperture module 100 is electrically connected to the driving module 120.

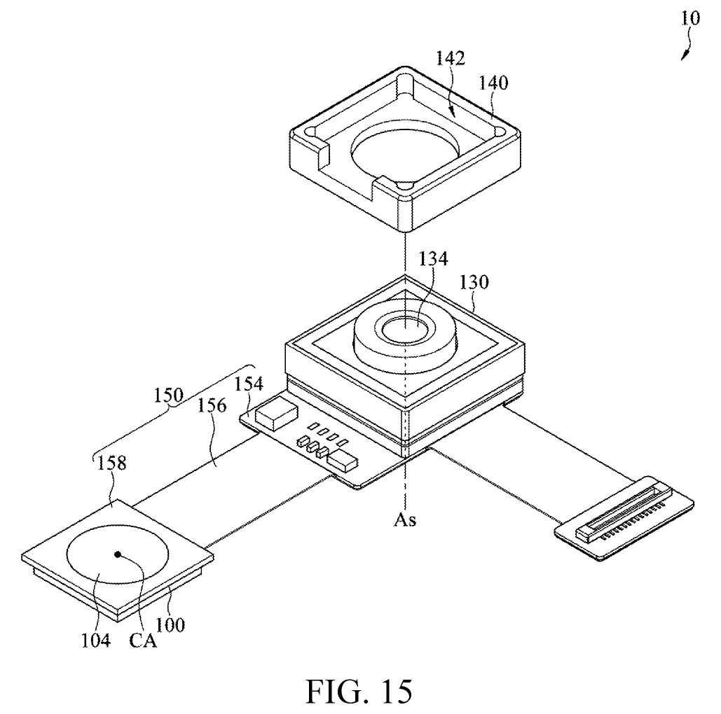

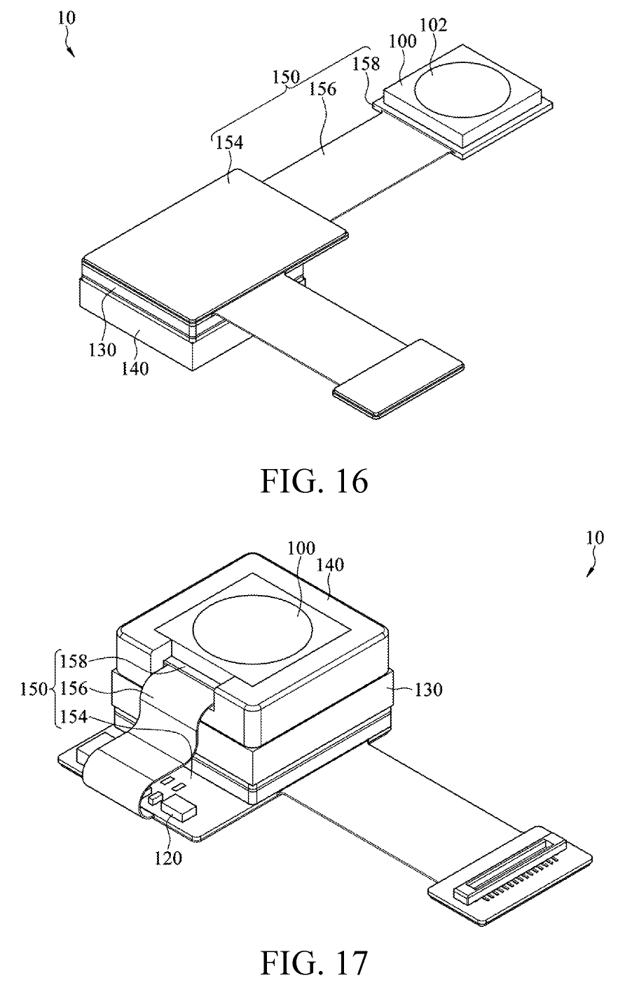

Referring to FIG. 15 to FIG. 17, FIG. 15 is a three-dimensional exploded view of an image capturing device according to another embodiment. FIG. 16 is a three-dimensional view of the image capturing device of FIG. 15, showing an unfolded state of a circuit board. FIG. 17 is a three-dimensional view of the image capturing device of FIG. 16, showing a bent state of a circuit board. In some embodiments, the circuit board 150 of the image capturing device 10 includes a first board 154, a second board 156, and a third board 158. The first board 154 is connected to the third board 158 through the second board 156. The shooting module 130 and the driving module 120 are arranged on the first board 154. The liquid crystal aperture module 100 is arranged on the third board 158. The liquid crystal aperture module 100 may be fixed to the third board 158 through the conductive adhesive when the liquid crystal aperture module is arranged on the third board 158, and then the liquid crystal aperture module 100 is connected to the driving module 120 through an electrical connection among the first board 154, the second board 156, and the third board 158. The second board 156 is bendable to align the aperture center CA of the liquid crystal aperture module 100 with the sensing optical axis As of the sensing module 132 of the shooting module 130 after bending.

In this embodiment, the circuit board 150 may be a printed circuit board manufactured by a printed circuit board process. The first board 154 and the third board 158 may be a rigid-flex PCB. The second board 156 may be an FPC. In this way, an elasticity of the liquid crystal aperture module 100 when the liquid crystal diaphragm module is arranged upstream of the shooting module 130 in the optical path is increased while the liquid crystal aperture module 100 is electrically connected to the driving module 120.

In some embodiments, the base 140 is fixed to the shooting module 130 through gluing. After the second board 156 is bent to align the aperture center CA of the liquid crystal aperture module 100 with the sensing optical axis As of the sensing module 132 of the photographic module 130, the third board 158 and the base 140 may be cured with a colloid, thereby improving stability of the liquid crystal aperture module 100 arranged upstream of the shooting module 130 in the optical path.

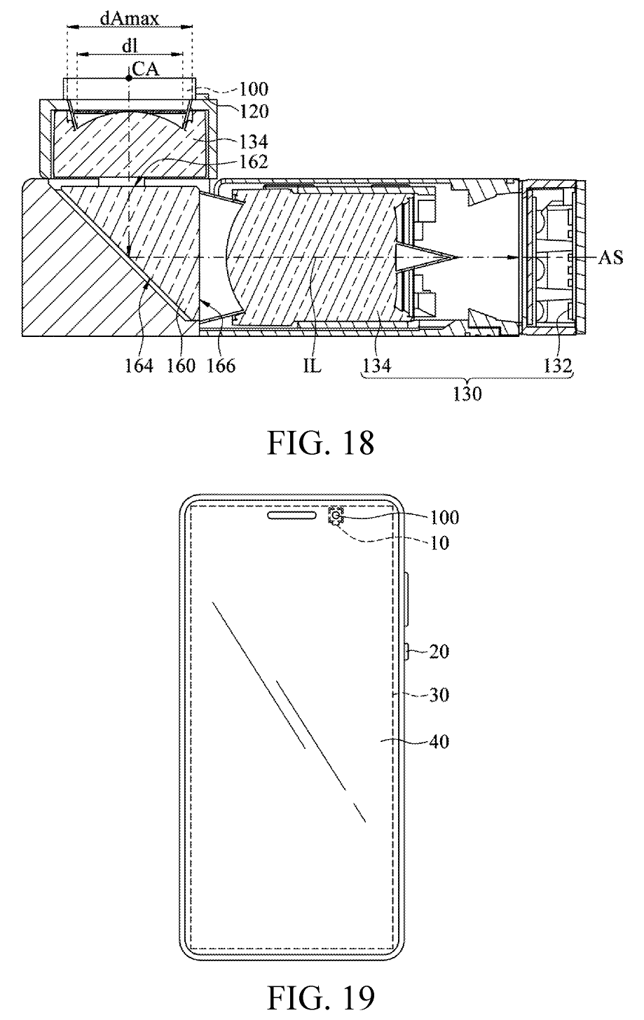

Referring to FIG. 18, FIG. 18 is a cross-sectional view of an image capturing device according to yet another embodiment. In some embodiments, the image capturing device 10 includes an optical steering element 160. The optical steering element 160 is located between the liquid crystal aperture module 100 and the shooting module 130, so that the image capturing device 10 forms a periscope shooting device.

Specifically, the optical steering element 160 includes an incident surface 162, a reflective surface 164 and an emergent surface 166. The incident surface 162 and the emergent surface 166 are light-transmissive surfaces. The reflective surface 164 is a mirror surface that reflects the light incident on the optical steering element 160 at a specific angle. The liquid crystal aperture module 100 is attached to the incident surface 162. When the image capturing device 10 is used for shooting, the imaging light IL from the object or the environment to be photographed that penetrates from the aperture center CA of the liquid crystal aperture module 100 penetrates the incident surface 162. The imaging light IL penetrates the emergent surface 166 and enters the sensing optical axis of the sensing module 132 after being reflected by the reflective surface 164.

In some embodiments, a lens, a filter, and the like may be additionally arranged between the optical steering element 160 and the shooting module 130.

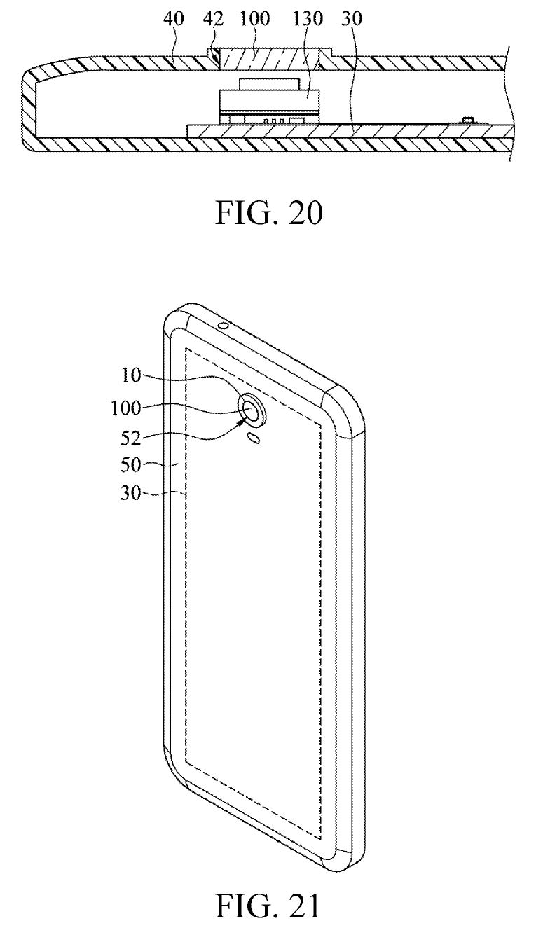

Referring to FIG.19 and FIG. 20, FIG. 19 is a schematic diagram of an electronic device with image capturing according to an embodiment. FIG. 20 is a cross-sectional view of the electronic device with image capturing of FIG. 19. An electronic device with image capturing includes an input interface 20, the image capturing device 10, a main board 30, and a display 40. The input interface 20 is configured to receive an input instruction from the user. The image capturing device 10 is connected to the input interface 20.

Still referring to FIG. 2 and FIG. 4, the image capturing device 10 includes the liquid crystal aperture module 100, the driving module 120 and the shooting module 130. The liquid crystal aperture module 100 includes the first polarizer 102, the second polarizer 104, the first substrate 106, the second substrate 108, and the liquid crystal layer 110. The liquid crystal layer 110 is located between the first substrate 106 and the second substrate 108. The first substrate 106 and the second substrate 108 are located between the first polarizer 102 and the second polarizer 104.

The driving module 120 is electrically connected to the liquid crystal aperture module 100. The liquid crystal layer 110 of the liquid crystal aperture module 100 includes a plurality of liquid crystal molecules 112. The liquid crystal molecules 112 each have an arrangement direction. When the driving module 120 applies a voltage to the liquid crystal aperture module 100 by electrically connecting the first substrate 106 and second substrate 108, the arrangement directions of the liquid crystal molecules 112 in the liquid crystal layer 110 is changed. Light may be allowed or not allowed to penetrate the liquid crystal layer 110.

The shooting module 130 is located downstream of the liquid crystal aperture module 100 in an optical path. The shooting module 130 includes the sensing module 132. The sensing module 132 has the sensing optical axis As. The liquid crystal aperture module 100 has the aperture center CA. The sensing optical axis As of the sensing module 132 is aligned with the aperture center CA of the liquid crystal aperture module 100. The imaging light IL from the object or the environment (referred to as a target object hereinafter) to be photographed by the user penetrates the liquid crystal aperture module 100 and enters the sensing module 132 of the shooting module 130. The sensing module 132 captures the imaging light IL of the target object based on the input instruction obtained by the input interface 20 and converts the image of the target object into an image signal.

The main board 30 is connected to the sensing module 132 of the image capturing device 10. In the embodiment in which the shooting module 130 is arranged on the circuit board 150, the circuit board 150 electrically connected to the sensing module 132 is electrically connected to the main board 30, so that power can be obtained from the main board 30. The sensing module 132 transmits the image signal to the main board 30, and the image signal is received by the main board 30.

In some embodiments, the main board 30 performs operations such as denoising, sharpening, contrast adjustment, and white balance calibration on the image signal after the image signal is received. The display 40 is connected to the main board 30. A processed image signal or an unprocessed image signal is outputted from the main board 30 to the display 40. The display 40 displays the image of the target object based on the image signal.

In some embodiments, the display 40 has an opening 42. The opening 42 is a region on the display 40 for the imaging light IL to enter the image capturing device 10. The image capturing device 10 is arranged on the main board 30 and located in the display 40. The image capturing device 10 corresponds to the opening 42 with the liquid crystal aperture module 100.

In some other embodiments, the shooting module 130 of the image capturing device 10 is arranged in the display 40 and fixed to the opening 42 with the liquid crystal aperture module 100. In this embodiment, an upper surface of the first polarizer 102 of the liquid crystal aperture module 100 may be flush with an upper surface of the display 40 or protrude from the upper surface of the display 40.

In some embodiments, the image capturing device 10 is used as a front lens of the electronic device. The display 40 may be, but not limited to, a touch screen or a general display screen (in other words, a general display screen which does not have a touch function). When the display 40 is the touch screen, the input interface 20 may be the display 40, or the input interface 20 may be a combination of one or more buttons on the electronic device.

In some other embodiments, the image capturing device 10 is used as a rear lens of the electronic device. Referring to FIG. 21, FIG. 21 is a schematic diagram of an electronic device with image capturing according to another embodiment. In some embodiments, the electronic device includes a housing 50. The housing 50 has a window 52. The main board 30 and the image capturing device 10 are arranged in the housing 50 and the display 40. The image capturing device 10 is located on the main board 30 and faces the window 52 with the liquid crystal aperture module 100.

In some other embodiments, the shooting module 130 of the image capturing device 10 is arranged in the housing 50 and the display 40 and fixed to the window 52 with the liquid crystal aperture module 100.

In some embodiments, the optical steering element 160 is implemented through a right-angle prism, and a reflective surface 164 of the optical steering element 160 may further be additionally implemented through a plane mirror, a beam splitter, and the like.

In some embodiments, the sensing module 132 of the shooting module 130 may be a photosensitive device, such as a complementary metal-oxide-semiconductor (CMOS) photoreceptor, a charge-coupled device (CCD) photoreceptor, and a back side illuminated (BSI) photoreceptor, that converts photons into electronic signals.

In some embodiments, the electronic device may be a mobile phone, a tablet computer, or the like.

Based on the above, that the driving module 120 applies the voltage to the liquid crystal molecules 112 in the liquid crystal aperture module 100 allows the liquid crystal aperture module 100 to form the light-transmissive region 113a or the light-proof region 113b, to allow, not allow, or partially allow the light to penetrate and control the transmittance when the light penetrates, thereby controlling the light amount entering the shooting module 130 when the image capturing device 10 is used for shooting.

Certainly, the present invention may have various other embodiments. Without departing from the spirit of the present invention and an essence thereof, a person skilled in the art may make various corresponding changes and modifications according to the present invention, but these corresponding changes and modifications shall fall within the protection scope of the claims of the present invention.

What is claimed is:

1. An image capturing device, comprising:
a liquid crystal aperture module, comprising a first polarizer, a second polarizer, a first substrate, a second substrate, and a liquid crystal layer, wherein the liquid crystal layer is located between the first substrate and the second substrate, the first substrate and the second substrate are located between the first polarizer and the second polarizer, the liquid crystal layer comprises a plurality of liquid crystal molecules, the plurality of liquid crystal molecules each have an arrangement direction, and the liquid crystal aperture module has an aperture center;
a driving module, electrically connected to the first substrate and the second substrate of the liquid crystal aperture module to control the arrangement direction of each liquid crystal molecule of the liquid crystal layer to change; and
a shooting module, located downstream of the liquid crystal aperture module in an optical path, wherein the shooting module comprises a sensing module having a sensing optical axis, and the sensing optical axis is aligned with the aperture center of the liquid crystal aperture module.

2. The image capturing device according to claim 1, wherein the arrangement directions of the liquid crystal molecules of the liquid crystal layer comprise a first direction and a second direction, the driving module controls a part of the plurality of liquid crystal molecules to be arranged in the first direction, and the liquid crystal molecules arranged in the first direction form a light-transmissive region to allow imaging light to penetrate and enter the shooting module, the driving module controls a part of the plurality of liquid crystal molecules to be arranged in the second direction, and the liquid crystal molecules arranged in the second direction form a light-proof region to prevent the imaging light from penetrating and entering the shooting module.

3. The image capturing device according to claim 2, wherein the shooting module further comprises a lens module located between the liquid crystal aperture module and the sensing module, a side of the lens module facing the liquid crystal aperture module has a lens diameter, the liquid crystal aperture module has a maximum aperture diameter, and the maximum aperture diameter is greater than or equal to the lens diameter.

4. The image capturing device according to claim 1, wherein the driving module comprises a driving circuit and a controller, the controller is electrically connected to the shooting module, and the controller controls the driving circuit to apply a voltage to the liquid crystal aperture module, to change the arrangement direction of each liquid crystal molecule of the liquid crystal layer of the liquid crystal aperture module.

5. The image capturing device according to claim 1, wherein the plurality of liquid crystal molecules are twisted nematic (TN) liquid crystals, vertical alignment (VA) liquid crystals, or in-plane switching (IPS) liquid crystals.

6. The image capturing device according to claim 1, further comprising a base and a circuit board, wherein the shooting module and the driving module are arranged on the circuit board, the base is fixed to the shooting module and electrically connected to the driving module through a circuit, and the liquid crystal aperture module is arranged on the base and electrically connected to the base.

7. The image capturing device according to claim 6, wherein the circuit is formed on the base by laser direct structuring.

8. The image capturing device according to claim 6, wherein the circuit is a metal conductive sheet, and the metal conductive sheet is embedded in the base by insert molding.

9. The image capturing device according to claim 6, wherein the base comprises a plurality of contacts, each contact is applied with a conductive adhesive, and the first substrate and the second substrate are electrically connected to each contact through the conductive adhesive.

10. The image capturing device according to claim 1, further comprising a circuit board, wherein the circuit board comprises a first board, a second board, and a third board, the first board is connected to the third board through the second board, the shooting module and the driving module are arranged on the first board, the liquid crystal aperture module is arranged on the third board, and the second board is bendable, so that the liquid crystal aperture module is located on the shooting module, and the aperture center of the liquid crystal aperture module is aligned with the sensing optical axis of the sensing module of the shooting module.

11. The image capturing device according to claim 10, further comprising a base, wherein the base is fixed to the shooting module, and the liquid crystal aperture module is arranged on the base.

12. The image capturing device according to claim 1, further comprising an optical steering element located between the liquid crystal aperture module and the shooting module, wherein the optical steering element has an incident surface, a reflective surface, and an emergent surface, and the liquid crystal aperture module is attached to the incident surface, so that imaging light penetrating the aperture center of the liquid crystal aperture module is allowed to penetrate the incident surface, be reflected by the reflective surface, and penetrate the emergent surface to enter the sensing optical axis of the sensing module.

13. An electronic device with image capturing, comprising:
an input interface, configured to receive an input instruction;
an image capturing device, connected to the input interface and comprising:
a liquid crystal aperture module, comprising a first polarizer, a second polarizer, a first substrate, a second substrate, and a liquid crystal layer, wherein the liquid crystal layer is located between the first substrate and the second substrate, the first substrate and the second substrate are located between the first polarizer and the second polarizer, the liquid crystal layer comprises a plurality of liquid crystal molecules, the plurality of liquid crystal molecules each have an arrangement direction, and the liquid crystal aperture module has an aperture center;
a driving module, electrically connected to the input interface, the first substrate, and the second substrate to control the arrangement direction of each liquid crystal molecule of the liquid crystal layer to change based on the input instruction;
a shooting module, located downstream of the liquid crystal aperture module in an optical path, wherein the shooting module comprises a sensing module having a sensing optical axis, the sensing optical axis is aligned with the aperture center of the liquid crystal aperture module, and the sensing module captures an image of a target object and converts the image into an image signal based on the input instruction;
a main board, connected to the image capturing device, wherein the main board receives the image signal from the image capturing device; and
a display, connected to the main board, wherein the display has an opening, the liquid crystal aperture module is located at the opening, and the display displays an image based on the image signal after receiving the image signal through the main board.

14. An electronic device with image capturing, comprising:
an input interface, configured to receive an input instruction;
an image capturing device, connected to the input interface and comprising:
a liquid crystal aperture module, comprising a first polarizer, a second polarizer, a first substrate, a second substrate, and a liquid crystal layer, wherein the liquid crystal layer is located between the first substrate and the second substrate, the first substrate and the second substrate are located between the first polarizer and the second polarizer, the liquid crystal layer comprises a plurality of liquid crystal molecules, the plurality of liquid crystal molecules each have an arrangement direction, and the liquid crystal aperture module has an aperture center;
a driving module, electrically connected to the input interface, the first substrate, and the second substrate to control the arrangement direction of each liquid crystal molecule of the liquid crystal layer to change based on the input instruction;
a shooting module, located downstream of the liquid crystal aperture module in an optical path, wherein the shooting module comprises a sensing module having a sensing optical axis, the sensing optical axis is aligned with the aperture center of the liquid crystal aperture module, and the sensing module captures an image of a target object and converts the image into an image signal based on the input instruction;
a main board, connected to the image capturing device, wherein the main board receives the image signal from the image capturing device;
a display, connected to the main board, wherein the display displays an image based on the image signal after receiving the image signal through the main board; and
a housing, having a window, wherein the main board and the shooting module are arranged in the housing and the display, and the liquid crystal aperture module is arranged in the window.
